(19) United States
(12) Patent Application Publication
(10) Pub. No.: US 2024/0337796 A1
(43) Pub. Date: Oct. 10, 2024

(54) Photon Detector System with Distance Control

(71) Applicant: Single Quantum B.V., Delft (NL)

(72) Inventors: John VAN DER ENDE, Delft (NL); Johannes Willem Nicolaas LOS, Leiderdorp (NL); Andreas Walter FOGNINI, Den Haag (NL)

(21) Appl. No.: 18/573,774

(22) PCT Filed: Jul. 1, 2022
(86) PCT No.: PCT/EP2022/068338

§ 371 Date: Dec. 22, 2023

(30) Foreign Application Priority Data
Jul. 1, 2021 (NL) 2028604

(51) Int. Cl. G02B 6/42; G01J 1/02; G01J 1/04; G01J 1/44

(52) U.S. Cl. CPC G02B 6/4231; G01J 1/0204; G01J 1/0266; G01J 1/0425; G01J 1/0448; G01J 1/44; G02B 6/424; G01J 2001/442; G01J 2001/4446

(57) ABSTRACT

A photon detector system for detecting photons emitted from an optical fiber, the photon detector system comprising a receiving mechanism for receiving the optical fiber; a photon detector comprising a superconducting element and aligned with the receiving mechanism, the photon detector having an active area for detecting photons emitted from an end-face of the optical fiber received in the receiving mechanism and an urging mechanism for urging together the photon detector and the optical fiber.

The present invention relates to improved photon detector systems, in particular improved Superconducting Nanowire Single-Photon Detectors (SNSPDs) systems and a method of sensing with such photon detector systems with increased yield and detection efficiency.

Superconducting Nanowire Single-Photon detectors typically comprise an active area for detecting photons emitted from an optical fiber. More specifically, SNSPDs comprise an active area covered by a superconducting nanowire whose superconductivity is broken once a single-photon from an optical fiber is absorbed by the nanowire. The fiber-to-detector coupling in prior art detectors is typically realised by butt-coupling the fiber to the detector via a receiving mechanism, typically a Zirconia sleeve. The extremity of the fiber provided with a ferrule is then typically inserted within the sleeve. Alignment sleeves and ferrules are commercially available and are thus used to precisely align the fiber with the active area of the photon detector. As the fiber cannot be repositioned, the coupling and absorption of prior art systems depend on chance. The fabrication yield defined by the number of fabricated detectors operating above a certain efficiency threshold and the detector efficiency are for these reasons limitations of such prior art systems.

ESMAEIL ZADEH IMAN et al., in “Superconducting nanowire single-photon detectors: A perspective on evolution, state-of-the-art, future developments, and applications”, APPLIED PHYSICS LETTERS, volume 118, nr. 19, 13 May 2021 (2021-05-13), DOI: 10.1063/50045990, show superconducting nanowire single-photon detectors which typically have fiber-to-detector couplings as described above.

An object of the invention, next to other objects, is to provide photon detector systems with increased yield and detection efficiency.

This object, next to other objects, is met by a photon detector system according to claim 1. Specifically, this is met by a photon detector system for detecting photons emitted from an optical fiber comprising a receiving mechanism for receiving the optical fiber, a photon detector comprising a superconducting element and aligned with the receiving mechanism, the photon detector having an active area for detecting photons emitted from an end-face of the optical fiber received in the receiving mechanism and an urging mechanism for urging together the photon detector and the optical fiber. The distance between the end-face of the optical fiber and the active area of the photon detector is important to maximize the absorption of photons by the photon detector. By urging the photon detector and the optical fiber together, the distance between these elements can be controlled over time and/or set to a predetermined value and a predetermined field can be accurately obtained for a given wavelength at the level of the active area leading to an improved yield and an improved detection efficiency.

According to a preferred embodiment the urging mechanism comprises a spring-loaded mechanism. In this way, a simple mechanical arrangement can be offered to implement the urging function and set the distance to a predetermined value. Alternatively other passive mechanisms known in the art, if suitable for that urging use, may be envisaged.

According to a preferred embodiment, the urging mechanism comprises a piezo electric actuator. Yet other controllable actuators known in the art, if suitable for that urging use, may be envisaged. In this way, a variable control of the urging force can be selected to obtain a variable distance between the end-face of the optical fiber and the active area. Such a variable distance control may be beneficial to tune for example the optical cavity. It is further noted that the urging mechanism may be a controllable actuator like a piezo electric actuator, a passive mechanism like a spring-loaded mechanism or a combination of both.

According to a preferred embodiment, a spacer element is arranged between photon detector and the optical fiber for spacing the end-face of the optical fiber from the active area of the photon detector. The spacer element sets thus the minimum distance between the end-face of the optical fiber and the active area of the photon detector when the urging mechanism urges the photon detector and the fiber provided on each side of the spacer together, i.e. towards each other along the direction of an axis of the optical fiber, also called the direction of the optical access. In this way the distance between the end-face of the optical fiber and the active area of the photon detector is set accurately. It is noted that when the urging mechanism is a spring-loaded mechanism, the use of a spacer is particularly beneficial. Indeed once overcoming friction, the spring-loaded mechanism may move the optical fiber all the way to the active area in which case a spacer ensures a minimum distance between the end-face of the optical fiber and the active area of the photon detector. It is noted that when the urging mechanism is a piezo electric actuator, the spacer may be dispensed with, if the actuator is able to control the displacement of the optical fiber in both directions along the direction of the optical access. For example when the piezo electric actuator is fixed to the optical fiber in such a way that it can push and pull the optical fiber, a spacer may be dispensed with.

According to a preferred embodiment, the urging mechanism is configured such that in use the optical fiber is urged to abut onto the spacer element and/or the active area is urged to abut onto the spacer element. In this way a freedom of movement of these elements with respect to each other along the fiber axis direction is blocked and the distance between the end-face of the optical fiber and the active area of the photon detector is set to be at least equal to the thickness of the spacer element in the direction of the fiber axis. Preferably the urging mechanism is configured to urge with a predetermined urging force to bring and maintain the optical fiber and/or the active area in contact with the spacer element.

According to a preferred embodiment, the photon detector and the spacer element are fixedly connected together and the urging mechanism is configured to urge the optical fiber towards the photon detector and the spacer element. In this way, the optical fiber is moved with respect to a static arrangement of a spacer element and a photon detector. Alternatively, the fiber is fixedly connected and the urging mechanism is configured to urge the photon detector and the spacer element towards the fiber. In this way the photon detector is moved by being pushed towards the fiber. For instance, a piezo electric actuator located under the photon detector urges the photon detector and the spacer element towards the static fiber.

According to a preferred embodiment, the photon detector system comprises a body, wherein the photon detector and the spacer element, and optionally the receiving mechanism, are mounted fixed on the body. In this way, the manipulation and fabrication of the photon detector system is simplified in that the urging mechanism can press the fiber towards the body holding the photon detector and the spacer element. Preferably, the system comprises a printed circuit board (PCB) as body of the detector system, wherein the photon detector and the spacer element, and optionally the receiving mechanism, are mounted fixed on the PCB.

According to a preferred embodiment, the spacer element is a spacer layer deposited on the photon detector. In this way, the spacer element can be manufactured during the fabrication of the detector itself, simplify the whole process and improving the accuracy of the determination of the thickness of the spacer layer. Forming a spacer element as layer contributes thus to controlling precisely the distance between the end-face of the optical fiber and the active area.

According to a preferred embodiment, the spacer layer is deposited on the photon detector leaving an empty space at its center. Preferably the empty space in the spacer layer covers substantially the active area. In this way, room is provided for accommodating a tip of the typically curved end-face of the optical fiber, while the periphery of the curved end-face of the optical fiber abuts on the spacer element.

According to a preferred embodiment, the spacer layer is made of one of gold, tungsten, or a dielectric material. In this way, materials already used for the fabrication of the electrical contacts can be used. Other alternatives may be chosen depending on circumstances to meet the requirements in terms of resistance and thermal behavior. The chosen material may be selected to deform in the elastic or plastic mode when urged by the urging mechanism.

According to a preferred embodiment, the urging mechanism is configured to engage a ferrule mounted at an extremity of the optical fiber. Preferably the urging mechanism is configured to engage a flange of the ferrule, the flange extending parallel to the active area. In this way, a force perpendicular to the active area can be transmitted to the optical fiber while respecting the alignment of the fiber with the receiving mechanism.

According to a preferred embodiment, the receiving mechanism is an alignment sleeve configured to receive a ferrule mounted to receive the extremity of the optical fiber. In this way a commercially available alignment sleeve may be used for alignment in combination with the urging mechanism.

In a preferred embodiment, the superconducting element comprises the active area. In this case the active area of the superconducting element is for detecting the photons emitted from the end-face of the optical fiber.

According to a preferred embodiment, the superconducting element is a superconducting layer. In this particular case, the urging together of the photon detector, comprising the superconducting layer, and the optical fiber results in a proper distance and aligning between the optical fiber and the detector due to the shape of the superconducting layer.

According to an even more preferred embodiment, the superconducting layer is a superconducting nanowire layer. In this way the photon detector can detect single photons emitted from the optical fiber.

According to another embodiment, the object of the invention is met by a method for detecting photons emitted from an optical fiber. The method comprises arranging a receiving mechanism for receiving the optical fiber; arranging a photon detector aligned with the receiving mechanism, the photon detector having an active area for detecting photons emitted from an end-face of the optical fiber received in the receiving mechanism; and urging together the photon detector and the optical fiber, and detecting photons emitted from the end-face of the optical fiber using the photon detector.

Although arranged for photon detectors, the spacer element and/or the urging mechanism could be arranged for other optical devices butt-coupling a fiber and an optical cavity in general. For instance the same principle could be used for coupling a fiber and a quantum dot single-photon source. The principle of urging mechanism and the spacer element described here is therefore not limited to single photon detectors with superconducting nanowire insofar as the concept of an efficient distance control between an end-face of an optical fiber and an active area as disclosed here may also be declined accordingly for other types of detectors.

This and other aspects of the present invention will now be described in more detail, with reference to the appended drawings showing currently preferred embodiments of the invention, wherein:

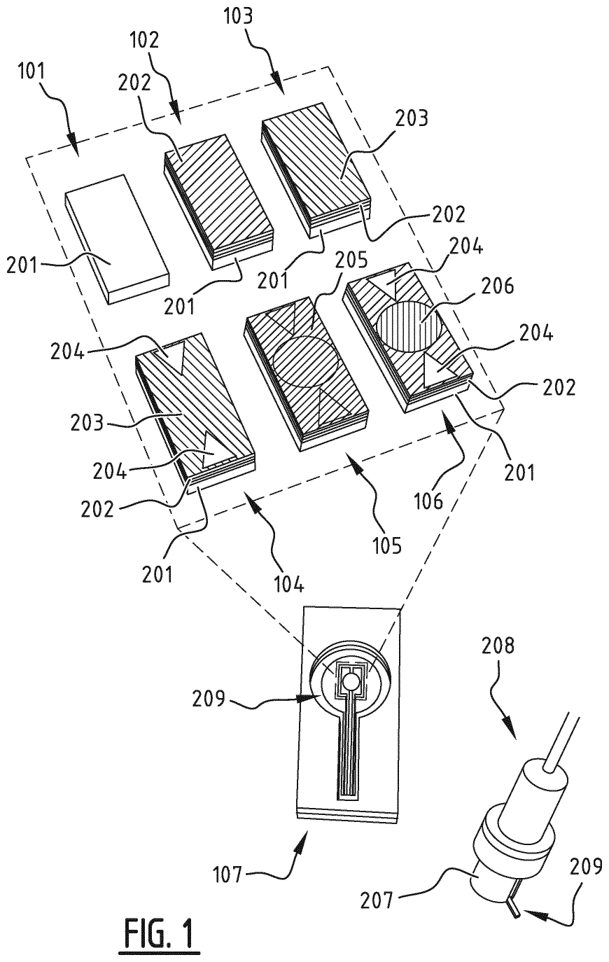

FIG. 1 illustrates the steps of fabrication of an SNSPD detector;

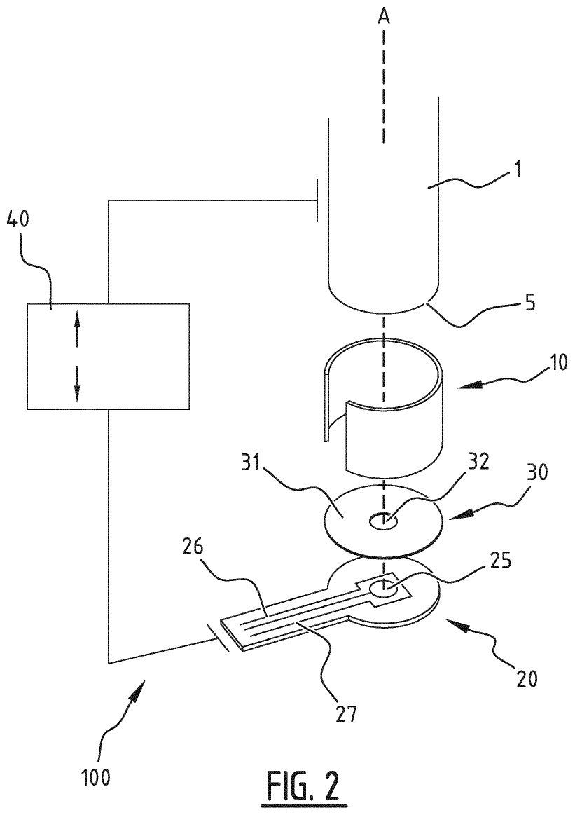

FIG. 2 illustrates a schematic exploded view of a detector system according to an embodiment when receiving an optical fiber.

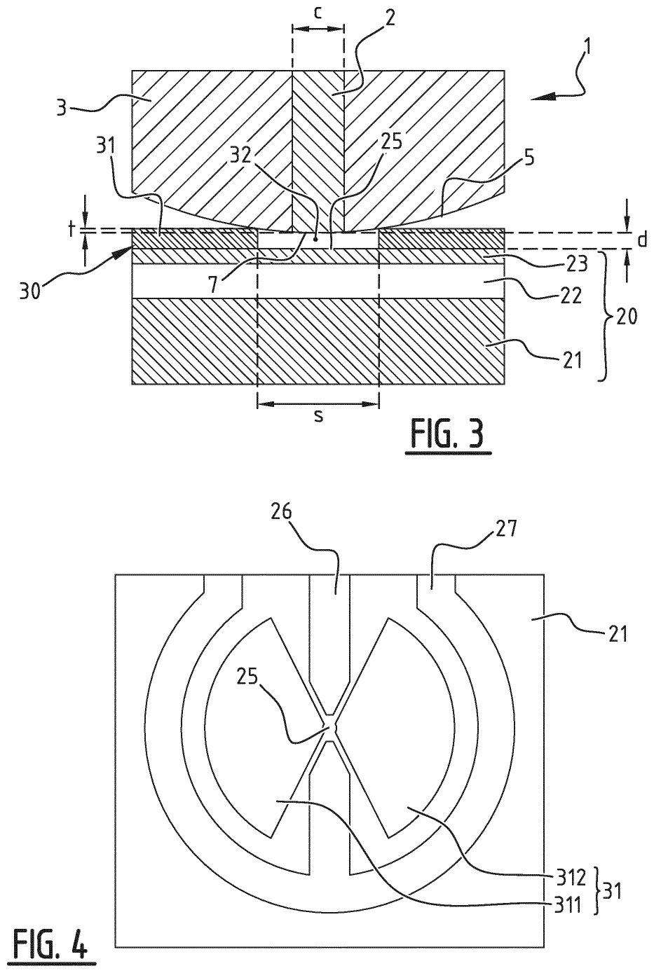

FIG. 3 illustrates a schematic cross section of a photon detector system according to FIG. 2;

FIG. 4 illustrates an enlarged top view of part of the detector system according to FIG. 2 without the optical fiber;

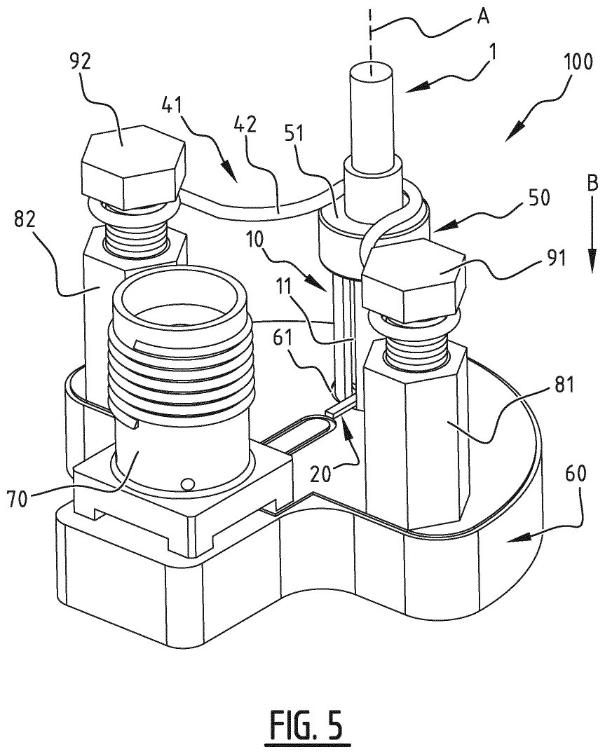

FIG. 5 illustrates a perspective view of a photon detector system according to an embodiment;

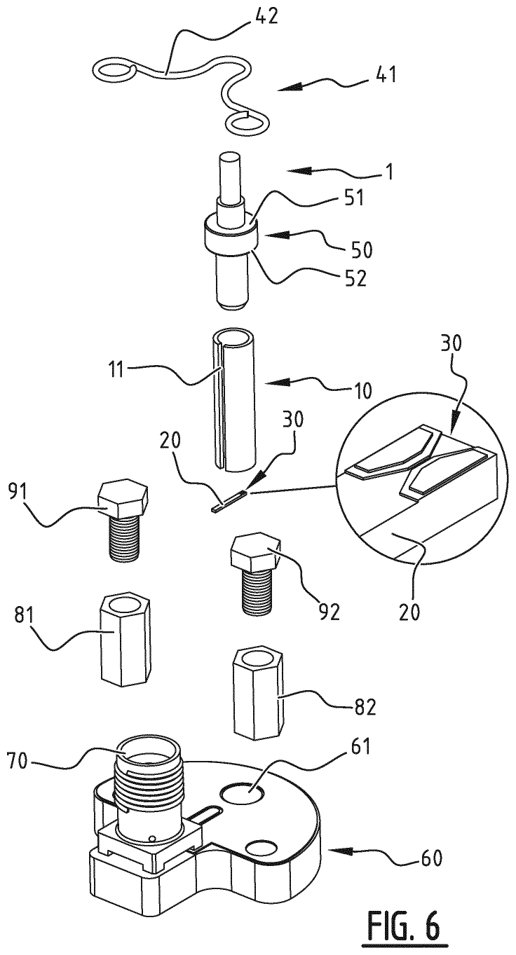

FIG. 6 illustrates an exploded view of the photon detector system of FIG. 5.

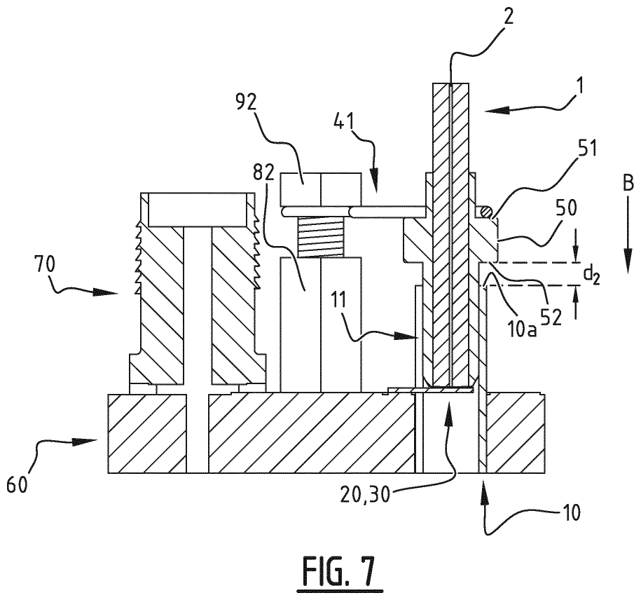

FIG. 7 illustrates a cross-section of the photon detector system of FIG. 5.

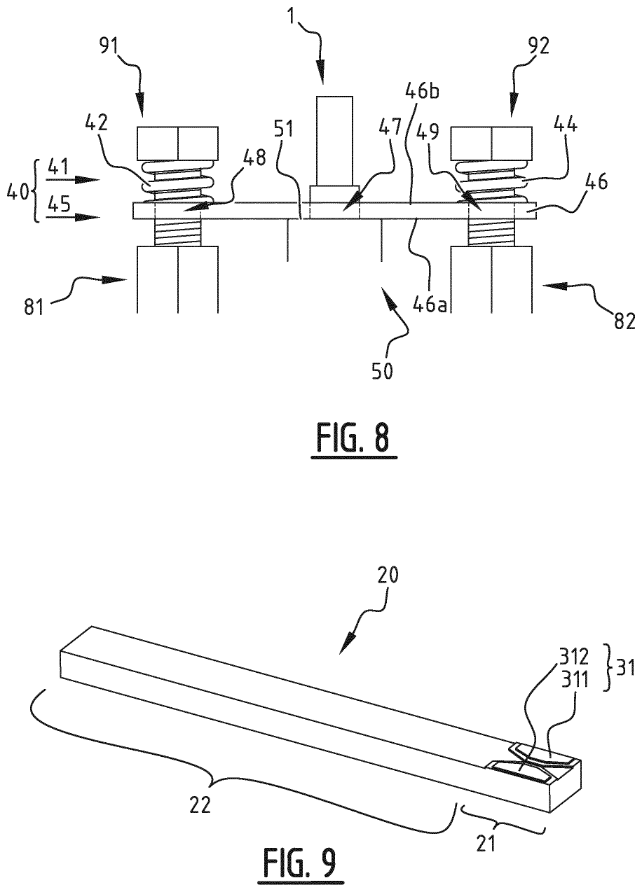

FIG. 8 illustrates a schematic cross-section of part of a photon detector system according to another embodiment;

FIG. 9 illustrates an enlarged perspective view of a photon detector.

FIG. 1 illustrates the steps of fabrication of an SNSPD detector. First in step 101 a silicon substrate 201 may be arranged, then in step 102 an optical cavity may be formed on the substrate by Distributed Bragg Reflector stacks 202. The optical cavity is meant to reflect the light that is not absorbed by the SNSPD in the first passing. Next in step 103 a superconducting layer 203 may be deposited, followed by the deposition of contacts in step 104, for instance gold contacts 204. The following steps 105 and 106 may be respectively E-beam lithography and reactive ion etching to etch a superconducting nanowire 206 in the superconducting layer 203. The superconducting nanowire may be shaped as a meander and defines a surface detector of the SNSPD detector for detecting photons. Finally in steps 107 chips 209 holding the nanowire pattern may be etched by deep silicon etching. For example chips 209 having a keyhole shape may be etched with the active area being located at the centre of the keyhole and contact electrodes extending in the straight portion of the keyhole. The keyhole shaped chips 209 may have the advantage of fitting within standard alignment sleeves 207 as receiving mechanism. An optical fiber 208 to be received in an alignment sleeve 207 may indeed typically be terminated with a ferrule with an outside diameter matching the inside diameter of the alignment sleeve, ensuring a precise alignment. It is however noted that instead of keyhole shape, detector chips may be formed as an elongated strip with the contact electrodes extending at one extremity and the active area located at the other extremity.

As mentioned in the introduction, one prior art technique for fiber to detector butt-coupling includes manually inserting the ferrule of the optical fiber in the alignment sleeve, the alignment sleeve housing in its centre the active area of the photon detector for detecting photons emitted from the optical fiber. This prior technique relies on measurements and manual positioning of the ferrule, leading to a complex fabrication process, low yield and low detection efficiency

FIG. 2 illustrates a schematic exploded view of a photon detector according to an embodiment. A photon detector system 100 is configured to detect photons emitted from an optical fiber 1. The photon detector system 100 comprises a receiving mechanism 10 for receiving the optical fiber 1, a photon detector 20 aligned with the receiving mechanism 10, the photon detector 20 having an active area 25 for detecting photons emitted from an end-face 5 of the optical fiber 1 received in the receiving mechanism 10. The photon detector system 100 comprises further a spacer element arranged between the photon detector 20 and the optical fiber 1 for spacing the end-face 5 of the optical fiber 1 from the active area 25 of the photon detector 20 and an urging mechanism 40 for urging together the photon detector 20 and the optical fiber 1.

The receiving mechanism 10 may be an alignment sleeve. The optical fiber 20 may be aligned with the photon detector 20 by the alignment sleeve 10. The alignment sleeve 10 may extend parallel to an axis A perpendicular to the active area 25, the axis A extending from a center of the active area of the photon detector 20. In this way the fiber 1 is butt-coupled to the photon detector 20. The dimensions of the active area 25 of the detector that the nanowire covers may be such that the active area 25 collects all photons emitted from the fiber 1.

The spacer element 30 may have a surface 31 covering at least part of the active area 25. The surface 31 of the spacer element may extend parallel to the active area 25 and may be arranged centered around the axis A. The spacer element 30 may define a minimum distance d (see FIG. 3) between the end-face 5 of the fiber 1 and the active area 25. It is noted here that the end-face 5 of the fiber 1 may have a curvature and the curved end-face 5 of the fiber 1 may protrude towards the outside of the fiber 1. The spacer element 30 may comprise an empty space 32 in the center of its surface, such that a vacuum area may be arranged at the center of the spacer element 30 to accommodate a tip of the curved end-face 5 of the fiber 1.

The urging mechanism 40 may urge according to a direction perpendicular to the active area, and in particular the urging mechanism 40 may, in use, urge together the photon detector 20 and the optical fiber 1 along the axis A. By urging together may be understood using a certain amount of force to press said elements towards each other. For example, the urging mechanism may be configured such that in use the optical fiber may be urged to abut onto the spacer element. In this way, the fiber, the spacer element and the surface detector may respectively come in contact with each other. The urging mechanism may be a piezo actuator 40.

In an embodiment, the spacer element 30 and the active area 25 may already be fixedly connected together such that by urging the fiber 1 together with these elements 25 and 30, the fiber 1 may come in contact with the spacer element 30. In an alternative embodiment, the spacer elements 30 may be a separate element, free to move with respect to both the fiber 1 and the surface detector 25, in which case by urging the three elements together, the active area 25 may come in contact with the spacer element 30, which may in turn come in contact with the end-face 5 of the fiber 1. In still another embodiment, the spacer element 30 and the end-face 5 of the fiber 1 may already be fixedly connected together such that by urging the photon detector 20 together with the fiber 1 and the spacer element 30, the active area 25 may come in contact with the spacer element 30.

FIG. 3 illustrates a schematic cross section of a photon detector system according to FIG. 2. A detector 20 may comprise a superconducting layer 23, an embodiment of the superconducting element. The superconducting layer 23 has an active area 25. The active area 25 may be smaller than the whole surface of the superconducting layer 23, and may correspond to a surface covered by a nanowire meander. In particular the active area 25 may be such that it collects all of the photons emitted by the end-face 5 of the fiber 1. The fiber 1 may comprise a core 2 and a cladding 3. The end-face 5 of the fiber 1 may have a curvature and the curved end-face 5 of the fiber 1 may protrude towards the outside of the fiber 1. The active area 25 may have in one embodiment a diameter S substantially equal to the diameter C of the core 2 of the fiber 1. Alternatively the diameter S of the active area may be substantially larger than the diameter C of the core 2 of the fiber 1. The active area diameter S may in particular be substantially larger than the mode field diameter and therefore also larger than the diameter C of the core 2 of the optical fiber 1. The superconducting layer 23 may be deposited above a detector bottom cavity 22, formed over a substrate 21. The detector system 100 may comprise a spacer layer 31 forming the spacer element 30, the spacer layer 21 being deposited on the superconducting layer 23 of the photon detector 20. In particular the spacer layer may be deposited above the active area 25 to be arranged in between the photon detector 20 and the optical fiber 1. In the center part of the spacer layer 31 an empty space 32 may be provided. For example, the empty space 32 may define a vacuum space arranged to accommodate a tip 7 of the fiber 1 protruding from the end-face 5 of the fiber 1. The empty space 32 may have a diameter substantially equal to the diameter S of the active area 25. The end-face 5 of the optical fiber 1 may in use abut on the spacer layer 31 to space the end-face 5 of the optical fiber from the active area 25 of the photon detector 20 at a distance d while a tip 7 of the curved end-face 5 of the fiber 1 may protrude in the empty space 32 by a tip length t.

FIG. 4 illustrates an enlarged top view of part of the detector system according to FIG. 2 without the optical fiber. The spacer layer 31 may be composed of two areas 311 and 312 on either side of the contact electrodes 26 and 27. The contact electrodes may be connected to both ends of the nanowire included in the nanowire layer 23. The two areas 311 and 312 may not overlap the active area 25 in the center and may be shaped to cover a large portion of the area of the detector inside the receiving means excluding the active area 25. The areas 311 and 312 may be axisymmetric with respect to the axis A to ensure a substantially homogeneous contact surface with the end-face 5 of the fiber 1. Depending on the amount of bias exerted by the urging mechanism, the spacer layer areas 311 and 312 may be deforming in the plastic or elastic domain. A suitable material for the spacer element 30 may be gold or tungsten.

FIG. 5 illustrates a perspective view of a photon detector system according to an embodiment. The photon detector system 100 comprises a printed circuit board 60 on which are mounted a connector 70, the photon detector 20, the receiving mechanism 10 and two mounting supports 81 and 82. The photon detector 20, embodied as an elongated chip, may be bonded to the PCB 60 while extending over a hole 61 provided in said PCB 60. The hole 61 may further be provided for housing the receiving mechanism 10. The receiving mechanism 10 may be an alignment sleeve with a slit 11 extending along its whole length. The photon detector 20 may extend via the slit 11 in the sleeve 10 towards the connector 70. The connector 70 may be connected to the contact electrodes 26 and 27 of the photon detector 20. An optical fiber 1 may be provided with a ferrule 50 at its free extremity (see also the exploded view of FIG. 6). The fiber protrusion from ferrule may be a design parameter. The ferrule 50 may have an outer diameter matching the inside diameter of the alignment sleeve 10, ensuring the alignment of the fiber 1 with the active area 25 of the photon detector 20 along axis A. The ferrule 50 may comprise a first flange 51, extending radially from the axis A and oriented in use away from the active area 25, and a second flange 52 (see in particular FIGS. 6 and 7), extending radially from the axis A and oriented in use towards the active area 25.

In this embodiment the urging mechanism 40 may comprise two mounting supports 81 and 82 and a abutting mechanism 41 comprising a spring 42. The mounting supports 81 and 82 may be formed as two pillars on the PCB 60 extending on the same side of the PCB as the fiber 1 and the active area 25. The height of the mounting supports 81 and 82 with respect to the PCB 60 may substantially be equal to the distance between the flange 51 of the ferrule 50 and the PCB 60 when the ferrule 50 is manually inserted in the alignment sleeve 10.

The spring-loaded mechanism 41 may be configured to engage with the flange 51 to push the ferrule 50, and thus the fiber 1 received in the ferrule 50, towards the photon detector 20 mounted on the PCB 60, indicated with arrow B. In this way the photon detector 20, the spacer layer 31 disposed on the photon detector 20 and the end-face 5 of the fiber 1 are urged together. The alignment sleeve may, in particular, be arranged such that the spring-loaded mechanism 41 can engage the flange 51 of the ferrule 50 in the direction of the fiber axis without the flange 52 of the ferrule 50 engaging the alignment sleeve 10 in the direction of the fiber axis A. A distance d₂ is thus provided between an upper end 10a of the alignment sleeve 10 and the lower flange 52, such that movement of the flange 52, and therewith the ferrule 50 and fiber 1, in the direction B is not blocked by the alignment sleeve 10. Preferably, the distance between the end-face 5 of the fiber 1, particularly the core 2 thereof, and the active area 25 is thus determined by the spacer 31.

The spring-loaded mechanism 41 may be a single spring 42. The single spring 42 may have a free-form comprising a U shape portion with a bend profile such that, when compressed under blocking elements 91 and 92, it engages around the ferrule 50 with the flange 51 of the ferrule 50, to push the flange 51 towards the active area 25 in direction B. The spring-loaded mechanism 41 may have two connecting portions at each extremity for engaging with the blocking elements 91 and 92, for example screws. The blocking elements 91 and 92 may each be fixedly connected to the top surface of the mounting supports 81 and 82. The spring loaded mechanism 41 may be compressed, i.e. bend, in between the surface of the flange 51 and a surface of each of the blocking elements 91 and 92. The position of the blocking elements 91 and 92 may be adjusted, for example by screwing tighter the screws 91 and 92. The height of the mounting supports 81 and 82 may be adapted to the distance between the flange 51 and the PCB. Other blocking elements and other blocking structures may be envisaged by a skilled person in the art to block/compress the spring-loaded mechanism into place.

It is also noted that other alternatives of a spring-loaded mechanisms may be envisaged by a person skilled in the art. For example the spring-loaded mechanism may comprise one or more of an helix compression spring, a conical spring, a leaf spring, a torsion spring or a disc spring.

FIG. 6 illustrates an exploded view of the photon detector system 100 of FIG. 5. In this embodiment the spacer element 30 may be fixedly connected to the photon detector 20, while the ferrule 50 may be fixedly connected to the optical fiber 1. During fabrication of the photon detector system, first the alignment sleeve 11 may be inserted in the hole 61 provided in the PCB 60. Then the photon detector chip 20 on which the surface detector 25 is etched may be inserted in the sleeve with its elongated portion extending through a side opening of the alignment sleeve 11. The photon detector chip 20 may then be bonded in place to the PCB filling partially the hole 61 of the PCB. In the next step, the fiber 1 terminated by the ferrule 50 may be inserted in the alignment sleeve 11 such that the end-face 5 of the fiber 1 may face the active area 25 of the photon detector 20. Finally the spring-loaded mechanism 41 may be connected to the mounting supports 81 and 82 and may be arranged to engage the flange 51 of the ferrule 50 to push the ferrule 50 and its associated fiber 1 towards the active area 25 of the photon detector 20, i.e. to urge the end-face 5 of the fiber 1 onto the spacer element 30 . . . .

FIG. 7 illustrates a cross section of the photon detector system of FIG. 5. In use, the force exerted by the spring-loaded mechanism 41 is such that end-face 5 of the fiber 1 comes in contact with the spacer element 30. The hole 61 provided in the PCB 60 may be arranged such that the alignment sleeve 10 may traverse the PCB 60. In this way a commercially available alignment sleeve may be used.

FIG. 8 illustrates a schematic cross-section view of part of a photon detector system according to another embodiment, wherein corresponding numbers have been used for corresponding elements with respect to the embodiment of FIGS. 5-7. Parts not represented in FIG. 8 may be considered to be the same as in the embodiment of FIGS. 5-7. In this embodiment, the urging mechanism 40 may comprise a spring-loaded mechanism 41 and additionally an intermediate element 45, for instance a plate 46. The intermediate element 45 may be placed between the flange 51 of the ferrule 50 and the spring-loaded mechanism 41 and/or between the spring-loaded mechanism 41 and blocking elements 91, 92. The plate 46 may be for example provided with a first opening 47 to accommodate the ferrule 50, passing through the plate 46, and with at least two additional openings 47 and 48 to accommodate the blocking elements 91, 92, also passing through the plate 46. In this embodiment, the flange 51 of the ferrule 50 may engage with a first side 46a of the plate 46 while the spring loaded mechanism 41 may comprise at least two spring-loaded elements 43 and 44, for example two helix compression springs, each engaging on one side with a second side 46b of the plate 46 and on the other side with a surface of a respective blocking element 91 and 92. For stability, additional blocking elements with a respective spring loaded element may further be provided.

FIG. 9 illustrates a perspective view of a detector 20, comprising a detector area 21 on which a spacer layer 31 may be deposited on top of the active area 25, and a connector area 22 on which contact electrodes may be deposited. The spacer layer 31 may comprise two sector areas 311 and 312 separated by an empty space. The connector area 22 may in use extend through the slit 11 of the sleeve 10 towards the connector 60 of FIG. 5. At least a portion of the area 22 away from the surface on which the layer 31 is deposited may be bonded onto the PCB 60 of FIG. 5.

In an embodiment with an urging mechanism comprising a piezo electric actuator 40 (see for instance FIG. 2), the piezo electric actuator may be connected to the flange 51 of the ferrule 50 in such a way that it can push and pull the ferrule 50 and thus the optical fiber 1 (see the double arrow in actuator 40). In particular in embodiments with an actuator, which actively control the height of the fiber 1 with respect to the detection surface 25, a spacer element 30 may not be necessary.

It can also be envisaged that the urging mechanism comprises a combination of a spring for pulling and piezo-electric actuator for pushing the ferrule 50 and thus the optical fiber 1. A piezo electric actuator may be controlled via a controller (feedback or open loop) to adjust the position of the ferrule 50, and thus the optical fiber 1. For example, further tuning of the position of the optical fiber during operation may be performed based on the output results of the detector.

It will be understood that, when an element or feature such as the superconducting element, the superconducting layer and/or the superconducting nanowire layer is said to be superconducting in any part of this disclosure, that this element or feature is superconducting when in use at the superconducting temperature of that respective element or feature.

The disclosure comprises the following embodiments.

1. A photon detector system for detecting photons emitted from an optical fiber, the photon detector system comprising:
a receiving mechanism for receiving the optical fiber;
a photon detector aligned with the receiving mechanism, the photon detector having an active area for detecting photons emitted from an end-face of the optical fiber received in the receiving mechanism;
an urging mechanism for, in use, urging together the photon detector and the optical fiber.

2. The photon detector system according to embodiment 1, wherein the urging mechanism comprises a spring-loaded mechanism.

3. The photon detector system of any of the above embodiments, wherein the urging mechanism comprises a piezo electric actuator.

4. The photon detector system of any of the above embodiments, wherein the photon detector further comprises a spacer element arranged between the photon detector and the optical fiber for spacing the end-face of the optical fiber from the active area of the photon detector.

5. The photon detector system of the previous embodiment, wherein the urging mechanism is configured such that in use the optical fiber is urged to abut onto the spacer element and/or the active area is urged to abut onto the spacer element.

6. The photon detector system of any of the above embodiments 4-5, wherein the photon detector and the spacer element are fixedly connected together and the urging mechanism is configured to urge the optical fiber towards the photon detector and the spacer element.

7. The photon detector system of the above embodiment, wherein the photon detector system comprises a body, wherein the photon detector and the spacer element, and optionally the receiving mechanism, are mounted fixed on the body.

8. The photon detector system of any of the above embodiments 4-7, wherein the spacer element is a spacer layer deposited on the photon detector.

9. The photon detector system of the previous embodiment, wherein the spacer layer is deposited on the photon detector leaving an empty space at its center.

10. The photon detector system of the previous embodiment, wherein the empty space in the spacer layer covers substantially the active area.

11. The photon detector system of any of the above embodiments 4-10, wherein the spacer layer is made of one of gold, tungsten, or a dielectric material.

12. The photon detector of any of the above embodiments, wherein the urging mechanism is configured to engage a ferrule mounted at an extremity of the optical fiber.

13. The photon detector system of the previous embodiment, wherein the urging mechanism is configured to engage a flange of the ferrule, the flange extending parallel to the active area.

14. The photon detector system of any of the above embodiments, wherein the receiving mechanism is an alignment sleeve configured to receive a ferrule mounted at the extremity of the optical fiber.

15. The photon detector system of any of the above embodiments, wherein the photon detector comprises a superconducting nanowire layer.

16. A method for detecting photons emitted from an optical fiber, the method comprising:
arranging a receiving mechanism for receiving the optical fiber;
arranging a photon detector aligned with the receiving mechanism, the photon detector having an active area for detecting photons emitted from an end-face of the optical fiber received in the receiving mechanism;
urging together the photon detector and the optical fiber,
detecting photons emitted from the end-face of the optical fiber using the photon detector.

Whilst the principles of the invention have been set out above in connection with specific embodiments, it is understood that this description is merely made by way of example and not as a limitation of the scope of protection which is determined by the appended claims.

1. A photon detector system for detecting photons emitted from an optical fiber, the photon detector system comprising:
a receiving mechanism for receiving the optical fiber;
a photon detector comprising a superconducting element, wherein the photon detector is aligned with the receiving mechanism, the photon detector having an active area for detecting photons emitted from an end-face of the optical fiber received in the receiving mechanism;
an urging mechanism for, in use, urging together the photon detector and the optical fiber.

2. The photon detector system according to claim 1, wherein the urging mechanism comprises a spring-loaded mechanism.

3. The photon detector system of any of the above claims, wherein the urging mechanism comprises a piezo electric actuator.

4. The photon detector system of any of the above claims, wherein the photon detector further comprises a spacer element arranged between the photon detector and the optical fiber for spacing the end-face of the optical fiber from the active area of the photon detector.

5. The photon detector system of the previous claim, wherein the urging mechanism is configured such that in use the optical fiber is urged to abut onto the spacer element and/or the active area is urged to abut onto the spacer element.

6. The photon detector system of any of the above claims 4-5, wherein the photon detector and the spacer element are fixedly connected together and the urging mechanism is configured to urge the optical fiber towards the photon detector and the spacer element.

7. The photon detector system of the above claim, wherein the photon detector system comprises a body, wherein the photon detector and the spacer element, and optionally the receiving mechanism, are mounted fixed on the body.

8. The photon detector system of any of the above claims 4-7, wherein the spacer element is a spacer layer deposited on the photon detector.

9. The photon detector system of the previous claim, wherein the spacer layer is deposited on the photon detector leaving an empty space at its center.

10. The photon detector system of the previous claim, wherein the empty space in the spacer layer covers substantially the active area.

11. The photon detector system of any of the above claims 4-10, wherein the spacer layer is made of one of gold, tungsten, or a dielectric material.

12. The photon detector of any of the above claims, wherein the urging mechanism is configured to engage a ferrule mounted at an extremity of the optical fiber.

13. The photon detector system of the previous claim, wherein the urging mechanism is configured to engage a flange of the ferrule, the flange extending parallel to the active area.

14. The photon detector system of any of the above claims, wherein the receiving mechanism is an alignment sleeve configured to receive a ferrule mounted at the extremity of the optical fiber.

15. The photon detector system of any of the above claims, wherein the superconducting element is a superconducting layer.

16. The photon detector system of claim 15, wherein the superconducting layer is a superconducting nanowire layer.

17. The photon detector system of any one of the above claims, wherein the superconducting element comprises the active area.

18. A method for detecting photons emitted from an optical fiber, the method comprising:
arranging a receiving mechanism for receiving the optical fiber;
arranging a photon detector aligned with the receiving mechanism, the photon detector having an active area for detecting photons emitted from an end-face of the optical fiber received in the receiving mechanism;
urging together the photon detector and the optical fiber,
detecting photons emitted from the end-face of the optical fiber using the photon detector.

19. A photon detector system for detecting photons emitted from an optical fiber, the photon detector system comprising:
a single photon detector comprising a superconducting element, the single photon detector having an active area for detecting photons emitted from an end-face of the optical fiber, wherein the superconducting element is a superconducting nanowire layer;
an urging mechanism for, in use, urging together the single photon detector and the optical fiber.

20. The photon detector system of claim 19, wherein the urging mechanism comprises at least one of a spring-loaded mechanism, a piezo electric actuator.
